(19) United States
(12) Patent Application Publication
(10) Pub. No.: US 2012/0050402 A1
(43) Pub. Date: Mar. 1, 2012

(54) LIQUID EJECTING APPARATUS

(75) Inventors: Kenichi KITAMURA, Shiojiri-shi (JP); Hiroyuki HAGIWARA, Matsumoto-shi (JP)

(73) Assignee: SEIKO EPSON CORPORATION, Tokyo (JP)

(21) Appl. No.: 13/215,341

(22) Filed: Aug. 23, 2011

(30) Foreign Application Priority Data
Aug. 25, 2010 (JP) 2010-187955

(51) Int. Cl. B41J 2/165; B41J 2/135

(52) U.S. Cl. 347/33; 347/44

(57) ABSTRACT

A liquid ejecting apparatus includes: a plurality of liquid ejecting heads for ejecting liquid from nozzles, the liquid ejecting heads arranged side by side with a gap each therebetween, each of the liquid ejecting heads including one side surface in a direction of side-by-side arrangement; the other side surface in the direction of side-by-side arrangement; a groove; and intersecting side surfaces, which intersect with the side surfaces, wherein the groove is formed in either one, or both, of opposed side surfaces of each two adjacent liquid ejecting heads arranged side by side, and the groove formed in the side surface or formed in each of the side surfaces extends from one of the intersecting side surfaces to the other.

The entire disclosure of Japanese Patent Application No: 2010-187955, filed Aug. 25, 2010 is expressly incorporated by reference herein.

### BACKGROUND

1. Technical Field

The present invention relates to a liquid ejecting apparatus that is equipped with a plurality of liquid ejecting heads for ejecting liquid retained in pressure chambers through nozzles by applying a pressure change in the pressure chambers, which are in communication with the nozzles.

2. Related Art

A liquid ejecting apparatus is a machine that is provided with a liquid ejecting head that can eject (discharge) liquid. Having such a liquid ejecting head, a liquid ejecting apparatus is capable of ejecting various kinds of liquid. An example of a liquid ejecting apparatus is an image recording apparatus such as an ink-jet printer. An ink-jet printer is provided with an ink-jet recording head, which is an example of various kinds of a liquid ejecting head. An ink-jet printer performs recording by ejecting ink in the form of ink droplets from nozzles of an ink-jet recording head toward a recording target medium (ejection target) such as a sheet of printing paper. As a result of the landing of discharged ink droplets on the surface of a recording target medium, dots are formed thereon. In this way, an ink-jet printer records an image and the like on a recording target medium. An ink-jet recording head is hereinafter simply referred to as a “recording head”. An ink-jet printer is hereinafter simply referred to as a “printer”. These days, the application of such a liquid ejecting apparatus is not limited to an image recording apparatus mentioned above. It is applied to various manufacturing apparatuses. For example, in a display manufacturing apparatus for the production of liquid crystal displays, plasma displays, organic electroluminescence (EL) displays, surface/plane emission displays (FED), or the like, a liquid ejecting apparatus is used as a machine for ejecting various liquid materials such as colorants and electrode materials onto a pixel formation area, an electrode formation area, and the like.

Recently, a so-called multi-head printer has been proposed in the art. A multi-head printer is equipped with a head unit that has the following structure: a plurality of recording heads is fixed to a head-fixing member such as a sub carriage in a row; each of the plurality of recording heads has a nozzle group that is made up of a plurality of nozzles formed in rows (for example, refer to JP-A-2008-273109). The sub carriage is a frame-like flat plate member that has an opening at a region where the plurality of recording heads is mounted. The sub carriage is made of synthetic resin for a lightweight design. Each of the recording heads is screwed to the sub carriage in a positioned state.

In a multi-head printer, a plurality of recording heads arranged side by side with a gap each therebetween with the nozzle formation surface thereof facing down (toward a recording target medium when an image or the like is printed on the recording target medium) is fixed to a sub carriage. Therefore, when ink sticking to the nozzle formation surface is wiped off by means of a wiping member such as a wiper or the like, in some cases, a part of the ink gathered up by the wiping member goes into a gap between the recording heads attached next to each other. When the gap between the recording heads is set at a small value that causes a capillary flow, the ink that has gone into the gap spontaneously rises due to capillary action toward the side opposite to the side where the nozzle formation surface is provided. In a structure in which electronic components such as a wired-and-mounted substrate or the like is provided at the side opposite to the nozzle-formation-surface side, there is a risk of a short-circuit failure of the wired-and-mounted substrate caused by the sticking of the ink that has risen along surfaces in the gap thereto.

In addition, there is a risk of a short-circuit failure of a wired-and-mounted substrate caused by mist. When liquid is ejected from nozzles, in some cases, a part of it turns into mist particles that drift in the air without landing onto a liquid ejection target medium such as a recording target medium or the like. In such a case, the generated mist rises in the gap to reach the wired-and-mounted substrate. The sticking of the mist particles to the wired-and-mounted substrate causes short circuiting.

### SUMMARY

An advantage of some aspects of the invention is to provide a liquid ejecting apparatus that can improve the reliability of its liquid ejecting head.

To achieve the above object, a liquid ejecting apparatus according to an aspect of the invention includes: a plurality of liquid ejecting heads for ejecting liquid from nozzles, the liquid ejecting heads arranged side by side with a gap each therebetween, each of the liquid ejecting heads including one side surface in a direction of side-by-side arrangement; the other side surface in the direction of side-by-side arrangement; a groove; and intersecting side surfaces, which intersect with the side surfaces, wherein the groove is formed in either one, or both, of opposed side surfaces of each two adjacent liquid ejecting heads arranged side by side, and the groove formed in the side surface or formed in each of the side surfaces extends from one of the intersecting side surfaces to the other.

In the above structure, each of the liquid ejecting heads includes one side surface in a direction of side-by-side arrangement; the other side surface in the direction of side-by-side arrangement; a groove; and intersecting side surfaces, which intersect with the side surfaces. The groove is formed in either one, or both, of opposed side surfaces of each two adjacent liquid ejecting heads arranged side by side. The groove formed in the side surface or formed in each of the side surfaces extends from one of the intersecting side surfaces to the other. Therefore, when liquid or mist goes into a gap between liquid ejecting heads attached next to each other and then rises along the side surfaces thereof, the groove(s) traps the liquid, the mist, etc. Therefore, it is possible to prevent the liquid, the mist, etc., from reaching a side opposite to a nozzle-formation-surface side. Consequently, such a trapping structure increases the reliability of the liquid ejecting heads. For example, in a structure in which electronic components such as a wired-and-mounted substrate or the like are provided at the side opposite to the nozzle-formation-surface side, since liquid or mist does not reach the electronic-component side, it is possible to prevent the sticking of the liquid or the mist to the electronic components.

In the above structure, it is preferable that the groove should be formed in both of the opposed side surfaces of each two adjacent liquid ejecting heads arranged side by side; and a height from a nozzle formation surface, in which the nozzles are formed, to the groove formed in one of the opposed side surfaces should be different from a height from the nozzle formation surface to the groove formed in the other.

In such a preferred structure, in which the groove is formed in both of the opposed side surfaces of each two adjacent liquid ejecting heads arranged side by side, since a height from a nozzle formation surface, in which the nozzles are formed, to the groove formed in one of the opposed side surfaces is different from a height from the nozzle formation surface to the groove formed in the other, it is possible to prevent interference between the groove formed in the one of the opposed side surfaces and the groove formed in the other. If the level of the groove formed in the one of the opposed side surfaces is equal to the level of the groove formed in the other, there is a risk of the mixing of liquid trapped by the groove formed in the one of the opposed side surfaces and liquid trapped by the other, which decreases the liquid-retaining capability of the grooves. In such a case, there is a risk of the dropping of the liquid retained in the grooves from the grooves due to its own weight. This does not occur with the preferred structure. Thus, it is possible to prevent a liquid ejection target medium or the inside of a liquid ejecting apparatus from stained by liquid dropping from the grooves. Since the groove formed in the one of the opposed side surfaces and the groove formed in the other make it easier to trap mist that has gone into the gap, it is possible to prevent liquid or the mist from reaching a side opposite to a nozzle-formation-surface side.

In the above structure, it is preferable that the groove should be inclined with respect to the nozzle formation surface.

Since the groove is inclined with respect to the nozzle formation surface, with such a preferred structure, liquid trapped by the groove flows down a slope to gather at a lower inclination end due to its own weight.

In the above structure, it is preferable that a width of the inclined groove at, at least, a lower inclination end thereof should be set at a value that ensures that a capillary force will be exerted on the liquid inside the groove, thereby making it possible to retain the liquid inside the groove.

In such a preferred structure, a width of the inclined groove at, at least, a lower inclination end thereof is set at a value that ensures that a capillary force will be exerted on the liquid inside the groove, thereby making it possible to retain the liquid inside the groove; therefore, the liquid trapped by the groove gathers at the lower inclination end to be retained thereat. Consequently, it is possible to prevent the liquid from dropping due to its own weight.

It is preferable that the liquid ejecting apparatus having the above structure should further include a maintenance mechanism that includes a wiping member for wiping the nozzle formation surface, and a supporting section that supports the wiping member and brings the wiping member into contact with the nozzle formation surface at the time of wiping, and an absorber that absorbs the liquid in a state in which the absorber is positioned adjacent to the supporting section, wherein, when the wiping member is brought into contact with the nozzle formation surface, the absorber is brought into contact with the lower inclination end of the groove so as to absorb the liquid that is retained at the lower inclination end.

With such a preferred structure, since the liquid ejecting apparatus further includes a maintenance mechanism that includes a wiping member for wiping the nozzle formation surface, and a supporting section that supports the wiping member and brings the wiping member into contact with the nozzle formation surface at the time of wiping, and an absorber that absorbs the liquid in a state in which the absorber is positioned adjacent to the supporting section, wherein, when the wiping member is brought into contact with the nozzle formation surface, the absorber is brought into contact with the lower inclination end of the groove so as to absorb the liquid that is retained at the lower inclination end, it is possible to collect liquid that gathers at the lower inclination end by using the absorber each time when the nozzle formation surface is wiped by using the wiping member.

### BRIEF DESCRIPTION OF THE DRAWINGS

The invention will be described with reference to the accompanying drawings, wherein like numbers reference like elements.

FIG. 1 is a perspective view that schematically illustrates an example of a part of the inner structure of a printer according to an exemplary embodiment of the invention.

FIG. 2 is a front view of the printer.

FIG. 3 is a plan view of the printer.

FIG. 4 is a right side view of the printer.

FIG. 5 is a plan view of a carriage assembly according to an exemplary embodiment of the invention.

FIG. 6 is a front view of the carriage assembly.

FIG. 7 is a right side view of the carriage assembly.

FIG. 8 is a bottom view of the carriage assembly.

FIG. 9 is a sectional view taken along the line IX-IX of FIG. 5.

FIG. 10A is a perspective view of a head unit according to an exemplary embodiment of the invention.

FIG. 10B is a perspective view of the head unit.

FIG. 11 is a plan view of the head unit.

FIG. 12 is a front view of the head unit.

FIG. 13 is a bottom view of the head unit.

FIG. 14 is a right side view of the head unit.

FIG. 15 is a sectional view that illustrates the structure of the carriage assembly in a more simplified way.

FIG. 16 is a perspective view that schematically illustrates an example of the structure of a recording head according to a first embodiment of the invention.

FIG. 17 is a front view that schematically illustrates an example of a part of the structure of recording heads according to the first embodiment of the invention that are arranged side by side.

FIG. 18 is a right side view of a head case according to the first embodiment of the invention.

FIG. 19 is a left side view of a head case according to the first embodiment of the invention.

FIG. 20 is a perspective view that schematically illustrates an example of the structure of a recording head according to a second embodiment of the invention.

FIG. 21 is a front view that schematically illustrates an example of a part of the structure of recording heads according to the second embodiment of the invention that are arranged side by side.

FIG. 22 is a right side view of a head case according to the second embodiment of the invention.

FIG. 23 is a left side view of a head case according to the second embodiment of the invention.

FIG. 24 is a diagram that schematically illustrates an example of the structure of a maintenance mechanism according to the second embodiment of the invention.

FIG. 25 is a left side view of a head case according to a third embodiment of the invention.

FIG. 26 is a front view of a head case according to a fourth embodiment of the invention.

### DESCRIPTION OF EXEMPLARY EMBODIMENTS

With reference to the accompanying drawings, an exemplary embodiment of the present invention will now be explained in detail. Although various specific features are explained in the following exemplary embodiments of the invention for the purpose of disclosing preferred modes thereof, the scope of the invention is not limited to the specific embodiments described below unless any intention of restriction is explicitly shown. In the following description, an ink-jet recording apparatus is taken as an example of a liquid ejecting apparatus according to an aspect of the invention. The ink-jet recording apparatus is hereinafter simply referred to as a “printer”.

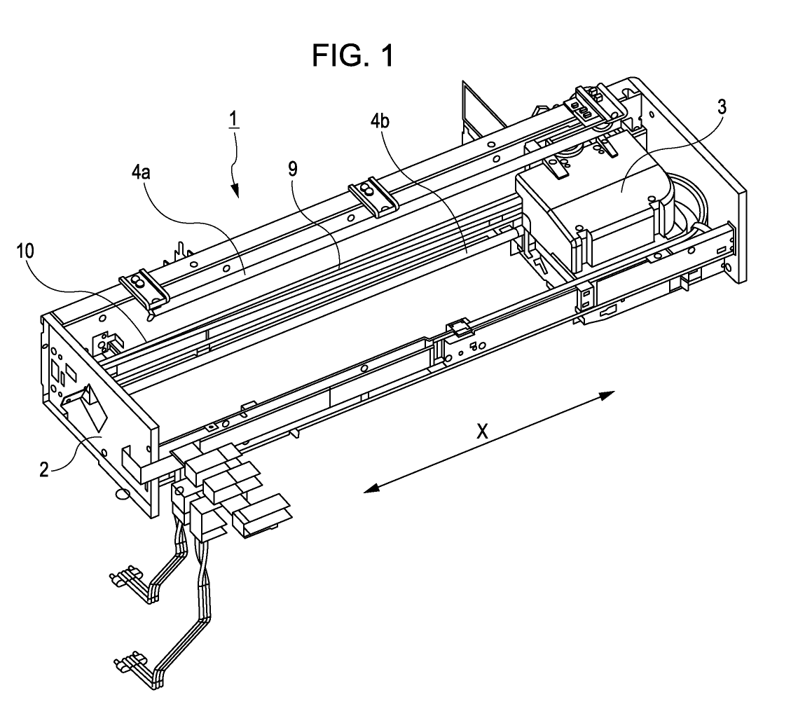

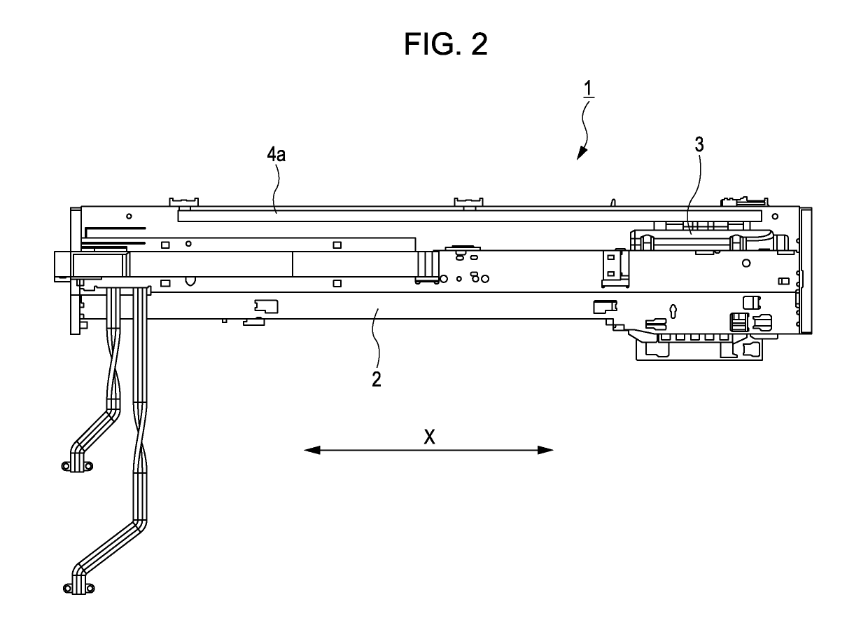

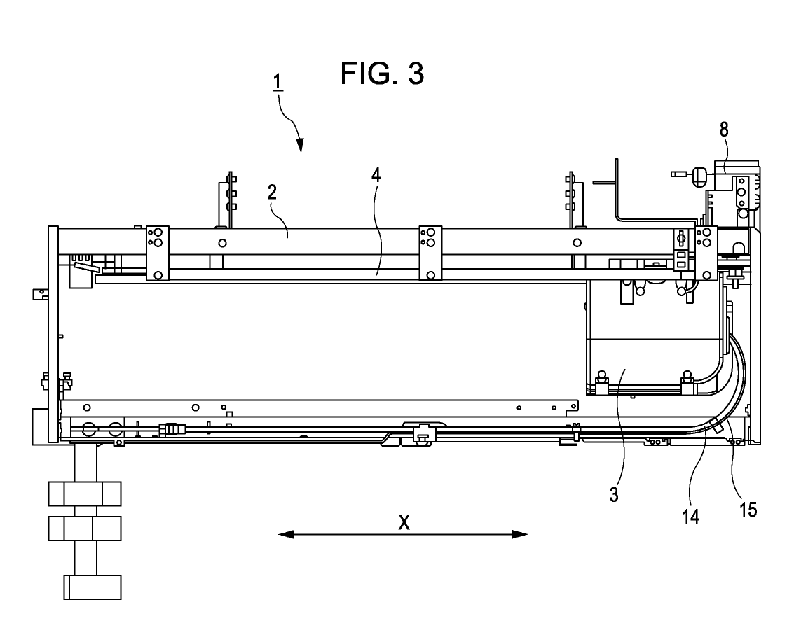

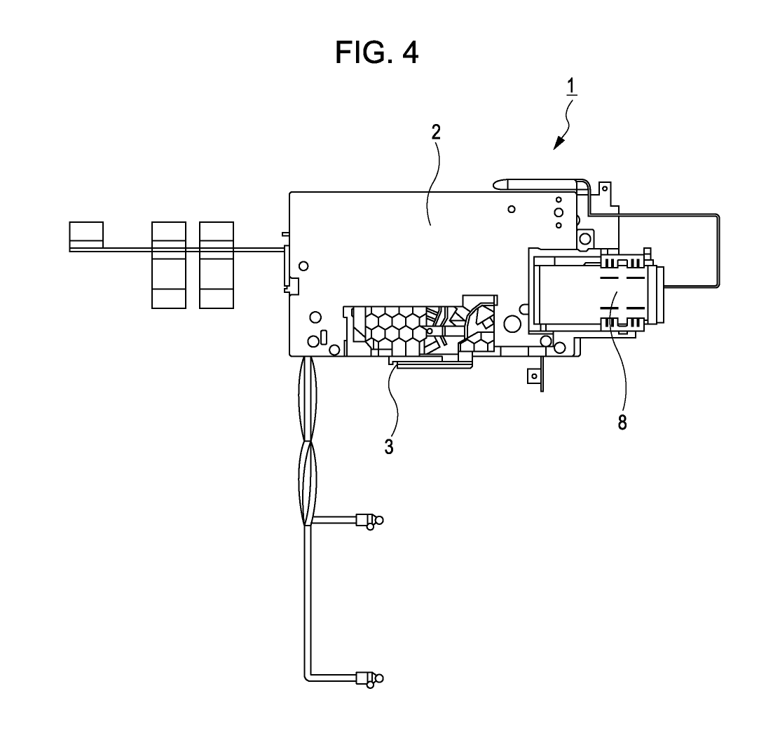

FIG. 1 is a perspective view that schematically illustrates an example of a part of the inner structure of a printer 1. FIG. 2 is a front view of the printer 1. FIG. 3 is a plan view of the printer 1. FIG. 4 is a right side view of the printer 1. The printer 1 illustrated in these drawings ejects ink, which is a kind of liquid, toward a recording target medium such as a sheet of recording paper, cloth, film, or the like (not shown). The recording target medium is a kind of a liquid ejection target medium, which is, for example, an object on which ink droplets discharged from a print head will land. The printer 1 has a frame 2. A carriage assembly 3, which is a kind of a head-unit holding member, is provided inside the frame 2. The carriage assembly 3 can reciprocate in a main scan direction, which is orthogonal to a direction in which a recording target medium is transported. The main scan direction is denoted as X in the accompanying drawings including FIG. 1. A pair of elongated upper and lower guide rods 4a and 4b is supported along the inside of the rear wall of the frame 2 of the printer 1 in the direction of the length of the frame 2. The guide rods 4a and 4b are supported in parallel with each other with a predetermined clearance therebetween. The guide rod 4 is inserted through a bearing cavity 7 (refer to FIG. 7), etc., which is formed at the back of the carriage assembly 3. With such a structure, the carriage assembly 3 can slide along the guide rod 4 in a supported state.

A carriage motor 8 is provided at the rear of the frame 2 at one end in the main scan direction X (right end in FIG. 3). The carriage motor 8 is a driving source that supplies power to move the carriage assembly 3. The driving shaft of the carriage motor 8 protrudes inward from the rear side of the frame 2. A driving pulley, which is not illustrated in the drawings, is provided at the tip of the shaft. The driving pulley rotates when driven by the carriage motor 8. A driven pulley, which is not illustrated in the drawings, is provided at the side opposite to the side of the driving pulley in the main scan direction X (left end in FIG. 3). A timing belt 9 is stretched between the driving pulley and the driven pulley. The carriage assembly 3 is attached to the timing belt 9. When the carriage motor 8 operates, the driving pulley rotates. The timing belt 9 turns due to the rotation of the driving pulley. As a result, the carriage assembly 3 moves along the guide rods 4a and 4b in the main scan direction X.

A linear scale (encoder film) 10 is provided on the inside of the rear wall of the frame 2 in parallel with the guide rods 4a and 4b along the main scan direction X. The linear scale 10 is a strip-shaped (band-like) member that is made of a transparent resin film. For example, the linear scale 10 has the following structure. A plurality of stripes that is not transparent is printed on the surface of a transparent base film. Each of the plurality of stripes extends in the direction of the width of the strip. The stripes have equal width. The stripes are printed at a constant pitch in the direction of the length of the strip. On the other hand, a linear encoder (not shown) is provided on the rear of the carriage assembly 3. The linear encoder optically reads the stripes of the linear scale 10. For example, the linear encoder is made up of a pair of a light-emitting element and a light-receiving element that are arranged opposite to each other. The linear encoder outputs an encoder pulse depending on a difference between the state of photo detection at each transparent part of the linear scale 10 and the state of photo detection at each stripe part thereof. That is, the linear encoder is a kind of a positional information outputting means. Functioning as such a means, the linear encoder outputs an encoder pulse corresponding to the scan position of the carriage assembly 3 as positional information in the main scan direction X. Therefore, the control unit (not shown) of the printer 1 can control the recording operation of a head unit 17 on a recording target medium while obtaining information on the scan position of the carriage assembly 3 on the basis of an encoder pulse supplied from the linear encoder. The printer 1 is configured to be able to perform so-called bidirectional recording processing. Specifically, the printer 1 can print characters, images, and the like on a sheet of recording paper both during the outward movement of the carriage assembly 3 and the homeward movement thereof. During its outward movement, the carriage assembly 3 travels from a home position, which is located at one end in the main scan direction X, to a full position, which is located at the other end in the main scan direction X. During its homeward movement, the carriage assembly 3 travels from the full position back to the home position.

As illustrated in FIG. 3, an ink-supplying tube 14 and a signal cable 15 are connected to the carriage assembly 3. Ink having each of a plurality of colors is supplied through the ink-supplying tube 14 to the corresponding one of a plurality of recording heads 18 of the head unit 17. Signals such as a driving signal are supplied through the signal cable 15. In addition to the components explained above, though not illustrated in the drawings, the printer 1 includes a cartridge attachment portion to which ink cartridges (source for supplying liquid) containing ink can be detachably attached, a medium transportation unit that transports recording paper, a capping unit that is used for capping the nozzle formation surface 53 of the recording head 18 that is in a stationary state on standby, and the like.

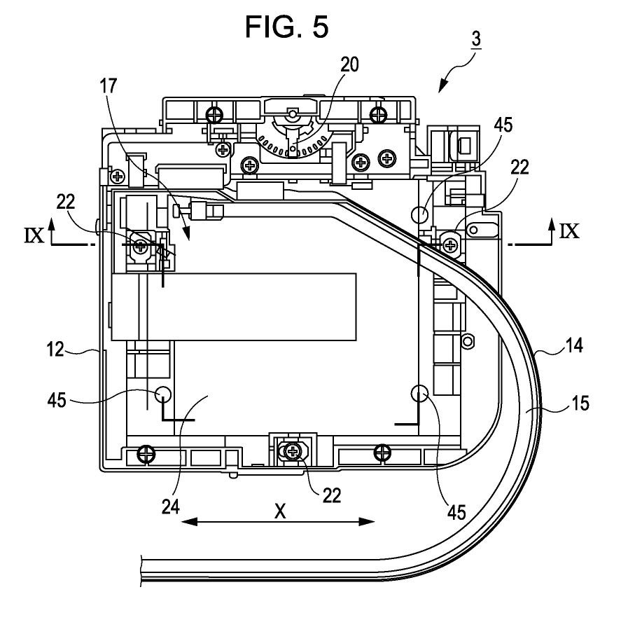

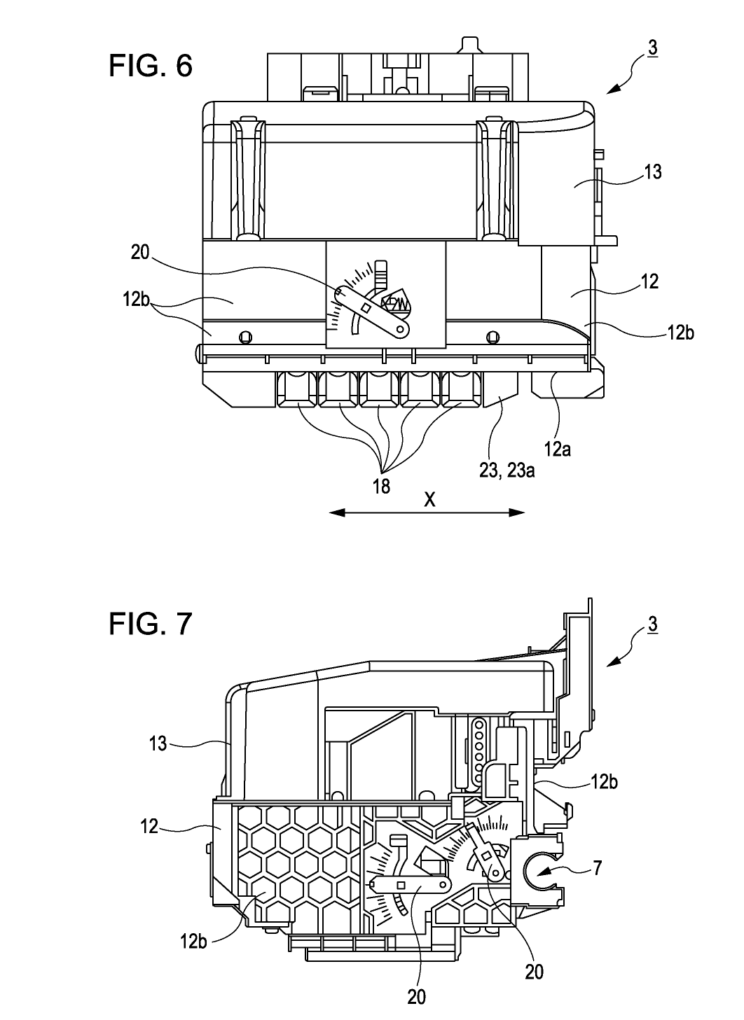

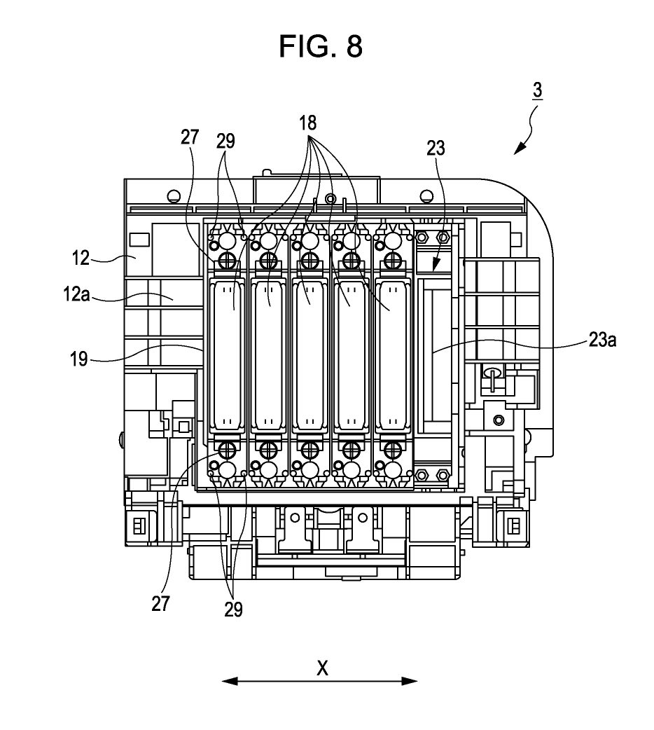

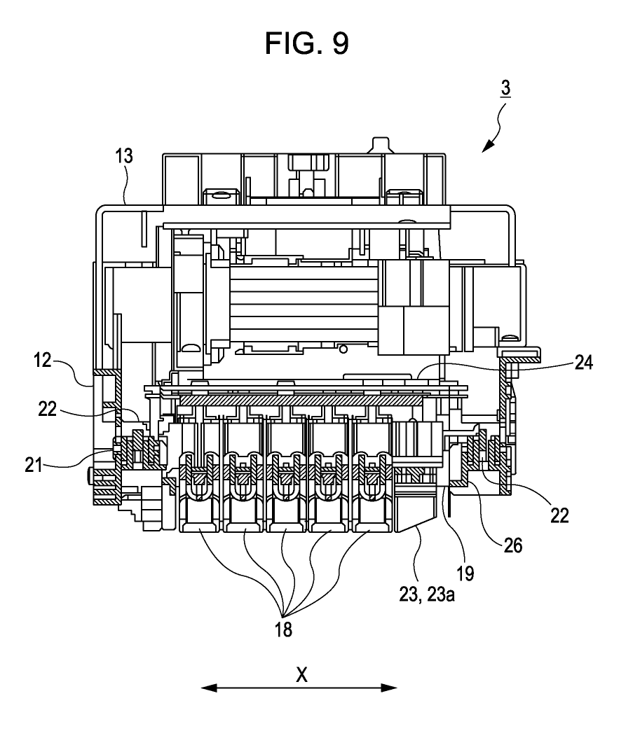

FIG. 5 is a plan view (top view) of the carriage assembly 3. FIG. 6 is a front view of the carriage assembly 3. FIG. 7 is a right side view of the carriage assembly 3. FIG. 8 is a bottom view of the carriage assembly 3. FIG. 9 is a sectional view taken along the line IX-IX of FIG. 5. Note that a state after the removal of a carriage cover 13 is illustrated in FIG. 5. The carriage assembly 3 is a hollow box-like member that is made up of two components, which are a carriage body 12 and the carriage cover 13, and can be separated into the lower component and the upper component. The head unit 17 is mounted inside the carriage body 12. The carriage body 12 has an opening at its top, which is usually covered by the carriage cover 13. A more detailed explanation of the head unit 17, which is a kind of a liquid ejecting head unit, will be given later. The carriage body 12 includes a substantially rectangular bottom plate portion 12a and sidewall portions 12b. Each of the sidewall portions 12b rises perpendicularly from the corresponding one of the four sides of the bottom plate portion 12a. The head unit 17 is housed in a space enclosed by the bottom plate portion 12a and the sidewall portions 12b. A bottom opening 19 is formed in the bottom plate portion 12a for the purpose of exposing the nozzle formation surface 53 of each of the plurality of recording heads 18 of the head unit 17 housed in the space. In a state in which the head unit 17 is mounted inside the carriage body 12, each of the plurality of recording heads 18 protrudes partially through the bottom opening 19 of the bottom plate portion 12a in such a manner that its nozzle formation surface 53 is located under the bottom of the carriage body 12, in other words, protrudes toward (is located closer to) a recording target medium during recording operation.

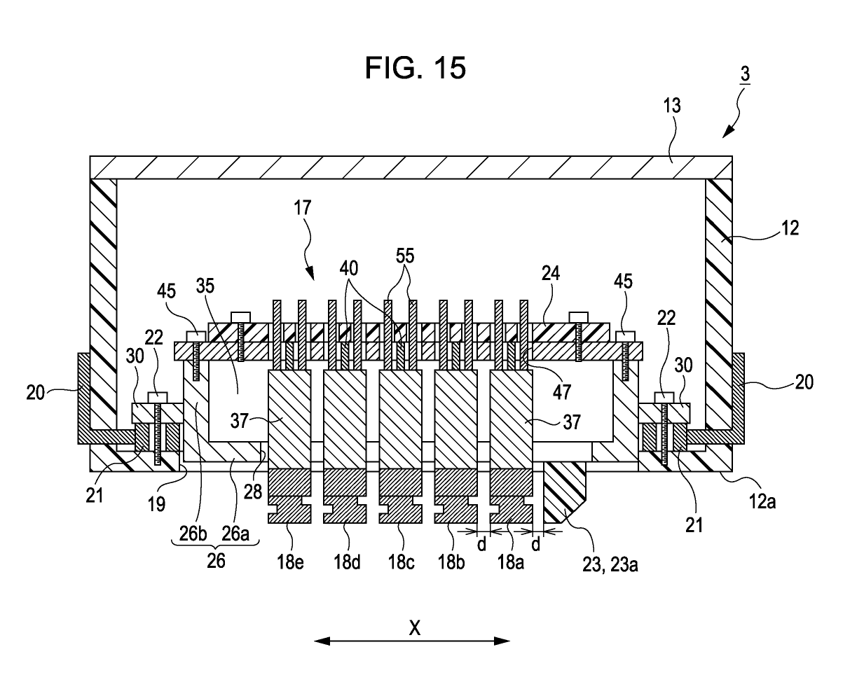

A plurality of eccentric cams 21 (refer to FIGS. 9 and 15) is provided between the carriage body 12 and the head unit 17. The eccentric cams 21 are used for adjusting the relative position/inclination (hereinafter referred to as “mount state”) of the head unit 17 mounted inside the carriage body 12. A plurality of levers 20 that is used for rotating these eccentric cams 21 is provided on the carriage body 12. The plurality of eccentric cams 21 rotates when these levers 20 are operated. When the eccentric cam 21 rotates, its height from the center of rotation to its circumferential surface fluctuates. It is possible to adjust the mount state of the head unit 17 housed in the space of the carriage body 12, such as the position of the head unit 17 and the inclination thereof, in relation to the carriage body 12 by utilizing the increase/decrease in the height of each of the plurality of eccentric cams 21.

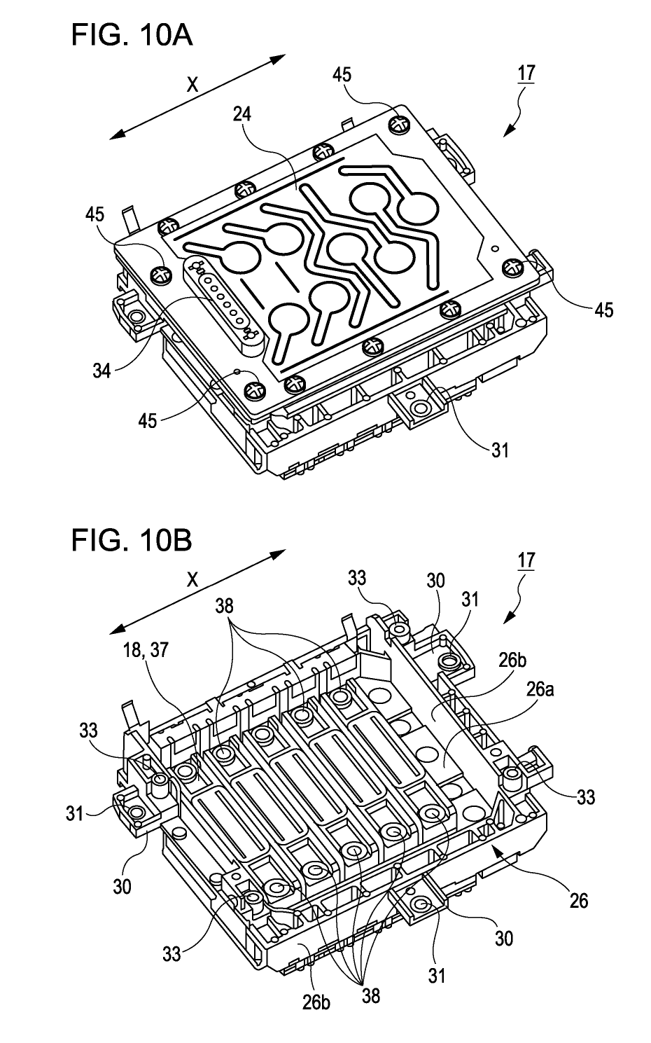

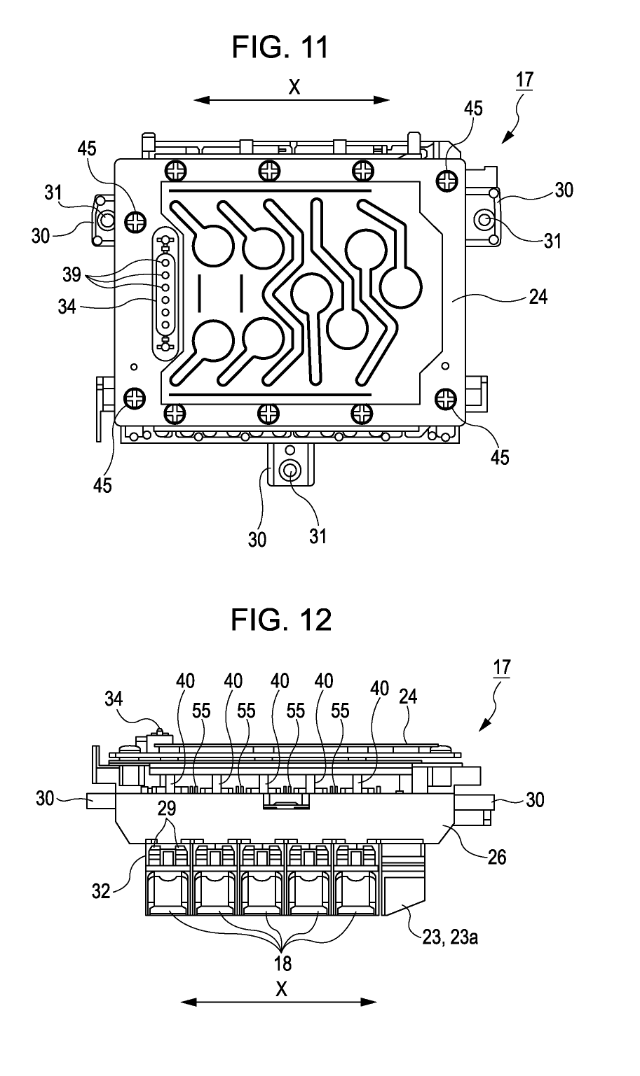

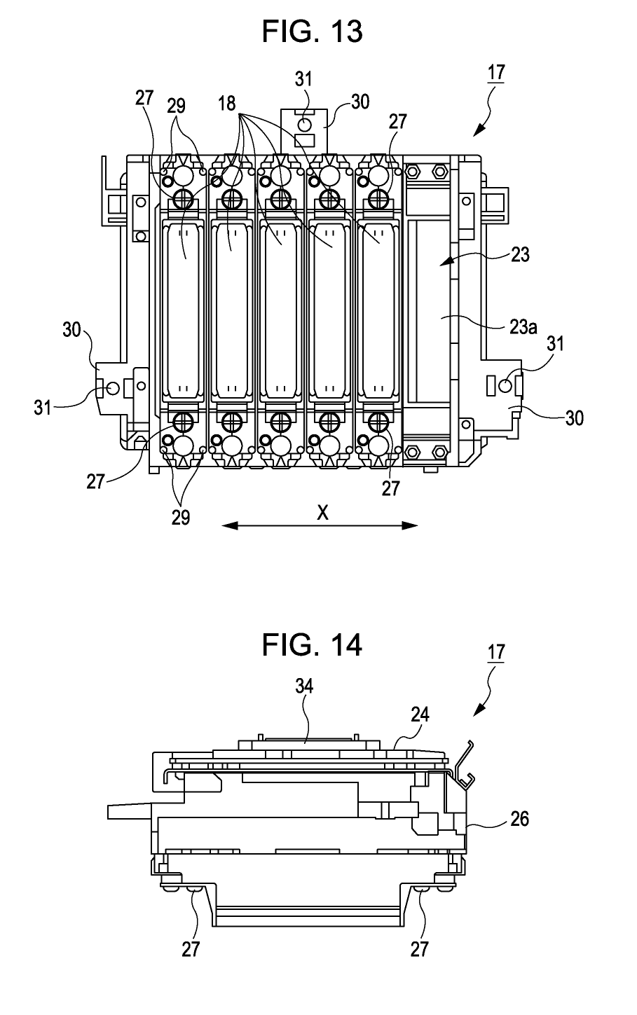

FIG. 10A is a perspective view of the head unit 17. Specifically, FIG. 10A illustrates a state in which a flow passage member 24 is attached as a part of the head unit 17. FIG. 10B is also a perspective view of the head unit 17. A state in which the flow passage member 24 has been detached therefrom is illustrated in FIG. 10B. FIG. 11 is a plan view (top view) of the head unit 17. FIG. 12 is a front view of the head unit 17. FIG. 13 is a bottom view of the head unit 17. FIG. 14 is a right side view of the head unit 17. FIG. 15 is a sectional view that illustrates the structure of the carriage assembly 3 in a more simplified way in order to facilitate the understanding of the present embodiment of the invention.

The head unit 17 is configured as an integrated unit of the plurality of recording heads 18 and the like. The head unit 17 includes a sub carriage 26 and the flow passage member 24. The sub carriage 26, which is a kind of a head-supporting member, is a member to which the recording heads 18 are attached. The sub carriage 26 is a hollow open-topped box-like member. Specifically, the sub carriage 26 includes a base plate portion 26a and sidewall portions 26b. The plurality of recording heads 18 is attached to the base plate portion 26a. Each of the sidewall portions 26b rises perpendicularly from the corresponding one of the four sides of the base plate portion 26a. A space that is enclosed by the base plate portion 26a and the sidewall portions 26b serves as a housing space 35 (refer to FIG. 15), which is a space in which at least a part of each of the plurality of recording heads 18 (mainly a sub tank 37) is housed. The sub carriage 26 according to the present embodiment of the invention is made of metal such as aluminum and thus has high rigidity. A head insertion opening 28 through which the plurality of recording heads 18 can be inserted (that is, a single opening that is shared by the plurality of recording heads 18) is formed at substantially the center of the base plate portion 26a. Therefore, the base plate portion 26a has a frame-like body. A plurality of fixing holes (female screws) 29 is formed in the lower surface (which is a surface that faces a recording target medium during recording operation) of the base plate portion 26a at positions corresponding to the attachment area of each of the plurality of recording heads 18 (refer to FIG. 12). Specifically, in the present embodiment of the invention, two fixing holes 29 are formed at each of two sides as viewed in a direction corresponding to the direction of a nozzle line at positions corresponding to the attachment holes of a spacer 32 described below for the attachment area of each of the plurality of recording heads 18 with the head insertion opening 28 formed between the two sides. In other words, the plurality of (i.e., four) fixing holes 29 is formed at four places respectively for the attachment area of each of the plurality of recording heads (i.e., four female screws in total for one attachment area).

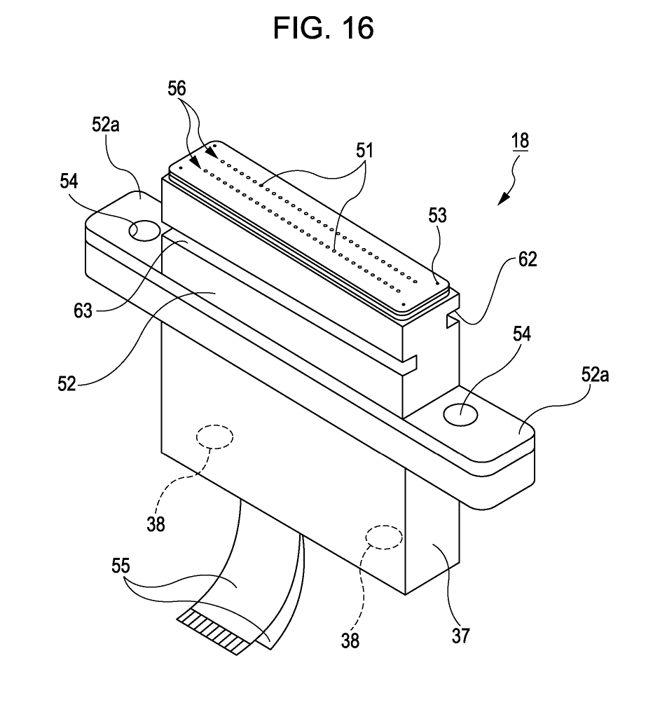

In the present embodiment of the invention, each of the plurality of recording heads 18 is attached to the sub carriage 26 with the spacers 32 (refer to FIG. 12) being interposed therebetween. The spacer 32 is a member that is made of synthetic resin. One spacer 32 is provided on the upper surface (which is a surface that is closer to the sub tank 37) of a flange portion 52a (refer to FIG. 16) at each of two sides for each of the plurality of recording heads 18. That is, two spacers 32 are provided for each of the plurality of recording heads 18. A head insertion hole (not shown) is formed at the center of the spacer 32 in its width direction, that is, in a direction orthogonal to the direction of a nozzle line. The head insertion hole corresponds to a spacer attachment hole 54 of the recording head 18. An attachment hole (not shown) is formed at each of two sides in the width direction of the spacer 32. The attachment hole corresponds to the fixing hole 29, which is formed in the sub carriage 26. That is, one head insertion hole and two attachment holes are formed in each of the plurality of spacers 32. In an assembly process before the attachment of the plurality of recording heads 18 to the sub carriage 26, the spacer 32 is screwed to the flange portion 52a at each of two sides of each of the plurality of recording heads 18. A spacer-fixing screw 27 (refer to FIG. 13, etc.) is used for fixing the spacer 32 thereto.

In the present embodiment of the invention, five recording heads 18 (18a to 18e) are attached to the base plate portion 26a in such a manner that these recording heads 18 are arranged in a row with a predetermined gap (denoted as d in FIG. 15) each therebetween in the direction orthogonal to the direction of nozzle lines. The orthogonal direction mentioned above is the same as the main scan direction X and is hereinafter referred to as “side-by-side-arrangement direction X”. The five recording heads 18a to 18e are attached thereto in a state illustrated in FIG. 15, specifically, in the following way. The sub tanks 37 (described later) of the five recording heads 18a to 18e are inserted into the housing space 35 through the head insertion opening 28 from below. The spacers 32 (refer to FIG. 12) are interposed between the flanges of recording heads 18a to 18e and the base plate portion 26a. In this state, head-fixing screws (not shown) are driven into the fixing holes 29 through the attachment holes of the spacers 32. The head-fixing screw is a kind of a head fixing means. The gap d each between the recording heads 18 is set at a value that causes the capillary flow of ink used in the present embodiment of the invention (capillary action). For example, in the present embodiment of the invention, the gap d is 0.1 mm. A relationship between the gap d and the surface tension of ink will be described later.

In the present embodiment of the invention, besides the five recording heads 18a to 18e, a head protection member 23 is attached to the base plate portion 26a outside the head row at a position next to the recording head 18 that is located at one end in the side-by-side-arrangement direction X (rightmost head in FIG. 15). The head protection member 23 is a member that protects the recording head 18 from, for example, recording paper during recording operation. For example, the head protection member 23 is made of synthetic resin. As illustrated in FIG. 13, the dimensions of the head protection member 23 in a plan view (i.e., depth in the nozzle-line direction and width in the direction orthogonal to the direction of a nozzle line) are approximately the same as the dimensions of the recording head 18. As with each of the plurality of recording heads 18, the head protection member 23 is screwed to the base plate portion 26a. The head protection member 23 has a tapered surface 23a. In a front view as illustrated in FIG. 15, the tapered surface 23a is formed as an inclined plane that is continuous from a front-end surface (a surface that faces a recording target medium during recording operation) and slopes up from the recording-head (18) side toward the opposite side. The tapered surface 23a is formed by obliquely cutting off an opposite-side corner of a front-end portion thereof, that is, a corner that is not closer to the recording head 18, or as if by obliquely cutting off the opposite-side corner.

As illustrated in, for example, FIG. 11, a flange portion 30 is formed on each of three of the (four) sidewall portions 26b of the sub carriage 26. The flange portions 30 extend sideward. An insertion hole 31 is formed through each of the three flange portions 30. The three insertion holes 31 correspond to attachment screw holes (not shown) that are formed in the bottom plate portion 12a of the carriage body 12 at three places respectively for the attachment of the head unit 17. After the position alignment of each of the three insertion holes 31 with the corresponding one of the three attachment screw holes of the bottom plate portion 12a of the carriage body 12, a head-unit-fixing screw 22 is driven (screwed) into each of the three attachment screw holes through the corresponding one of the three insertion holes 31. In this way, the head unit 17 is fixed to the carriage body 12 in a state in which the head unit 17 is housed in the inner space of the carriage body 12. As explained earlier, in a manufacturing process before the non-provisional fixing of the head unit 17 to the carriage body 12, the plurality of levers 20 described earlier is operated so as to adjust the mount state of the head unit 17 housed in the space of the carriage body 12, such as the position of the head unit 17 and the inclination thereof, in relation to the carriage body 12. Screw holes 33 for fixing the flow passage member 24 are formed at four places in the upper surface of the sidewall portions 26b of the sub carriage 26.

The flow passage member 24 is a low-profile box-like member. For example, the flow passage member 24 is made of synthetic resin. A plurality of ink distribution flow passages (not shown) is formed inside the flow passage member 24 with a partition wall formed each therebetween. Each of the plurality of ink distribution flow passages corresponds to an ink color. In addition, each of the plurality of ink distribution flow passages corresponds to a flow passage connection portion (portions) 38 of the sub tank 37 (which will be described later) of the recording head 18. A tube connection portion 34 is formed on the upper surface (a surface opposite to a surface fixed to the sub carriage 26) of the flow passage member 24. As illustrated in FIG. 11, a plurality of inlet ports 39 each of which corresponds to an ink color is formed inside the tube connection portion 34. Each of the plurality of inlet ports 39 is in communication with the ink distribution flow passage of the corresponding ink color. The ink-supplying tube 14 described earlier has an inner ink-supplying passage for each ink color. When the ink-supplying tube 14 is connected to the tube connection portion 34, the ink-supplying passage for each ink color becomes in communication with the corresponding inlet port 39 in a liquid-tight state. As a result, ink of each color, which has been supplied from the ink-cartridge side through the ink-supplying tube 14, flows into the corresponding ink distribution flow passage in the flow passage member 24 through the corresponding inlet port 39. Flow-passage insertion holes (not shown) are formed at four corners of the flow passage member 24. The flow-passage insertion holes correspond to the screw holes 33 of the sub carriage 26. Each of the flow-passage insertion holes is a through hole that goes in the direction of plate thickness. To fix the flow passage member 24 to the sub carriage 26, a flow-passage-fixing screw 45 is driven (screwed) into each of the plurality of screw holes 33 through the corresponding flow-passage insertion hole.

As illustrated in FIGS. 12 and 15, a connection flow passage member 40, which extends downward, is provided on the lower surface of the flow passage member 24 at a position corresponding to the flow passage connection portion 38 of the sub tank 37 of each of the plurality of recording heads 18. Each of the plurality of connection flow passage members 40 is a hollow cylindrical member that has an inner outlet passage (not shown) with which the ink distribution flow passage of the corresponding ink color is in communication. The connection flow passage member 40 is inserted in the flow passage connection portion 38 of the sub tank 37 of each of the plurality of recording heads 18 for liquid-tight connection. Having flowed through the ink distribution flow passage in the flow passage member 24, ink is supplied to the sub tank 37 of the recording head 18 through the connection flow passage member 40 and the flow passage connection portion 38. In other words, the ink-supplying tube 17 is indirectly connected to the sub tanks 37 through the flow passage member 24, which is provided therebetween.

FIG. 16 is a perspective view that schematically illustrates an example of the structure of the recording head 18, which is an example of a liquid ejecting head according to an aspect of the invention. Since the five recording heads 18, which can be attached to the sub carriage 26, have a common basic structure, one of them is shown in FIG. 16. The recording head 18 has a head case 52. A flow passage unit (not shown) in which ink flow passages including pressure chambers that are in communication with nozzles 51 are formed and a pressure generating means (not shown) such as piezoelectric vibrators or heating elements for causing a pressure change in ink inside the pressure chambers are provided inside the head case 52. A driving signal is supplied from the control unit of the printer 1 to the pressure generating means so as to drive the pressure generating means. The recording head 18 is configured to eject ink from the nozzles 51 onto a recording target medium such as recording paper as a result of the driving of the pressure generating means. The nozzles 51 from which ink is ejected are formed in rows, that is, as nozzle lines 56 (a kind of nozzle groups), in the nozzle formation surface 53 of each of the plurality of recording heads 18. Two nozzle lines 56 are formed next to each other as viewed in the direction orthogonal to the nozzle-line direction. Each of the nozzle lines 56 is made up of 360 nozzle orifices that are formed at a pitch of, for example, 360 dpi.

The head case 52 is a hollow substantially rectangular parallelepiped box-like member. The flow passage unit is fixed at the front-end side of the head case 52 with the nozzle formation surface 53 exposed to the outside. The pressure generating means and the like are housed in the inner space of the head case 52. The sub tank 37, from which ink is supplied to the flow passage unit, is attached to the base-surface side (the upper-surface side) of the head case 52. The base surface is a surface opposite to the front-end surface thereof. The flange portion 52a is formed at each of two sides in the nozzle-line direction at the upper-surface side of the head case 52. Each of the two flange portions 52a extends sideward. The spacer attachment hole 54, which corresponds to the aforementioned head insertion hole of the spacer 32, is formed through each of the two flange portions 52a. The spacer-fixing screw 27 is driven into the spacer attachment hole 54 when the spacer 32 is fixed to the flange portion 52a. Grooves 62 and 63, which will be described later, are formed respectively in the side surfaces 60 and 61 of the head cases 52 of each two adjacent recording heads 18 arranged side by side, or in other words, a side surface 60 of the head case 52 of the recording head 18 and a side surface 61 of the head case 52 of the next recording head 18 that face each other. Two sides facing each other (opposed to each other) are hereinafter referred to as “facing side surfaces”.

The sub tank 37 is a member through which ink flowing in from the flow passage member 24 can be supplied toward the pressure chambers of the recording head 18. The sub tank 37 has a self-sealing function for controlling the flow of ink into the pressure chambers by opening and closing its valve depending a change in inner pressure. The flow passage connection portion 38, to which the connection flow passage 40 of the flow passage member 24 is connected, is provided at both end regions in the nozzle-line direction in the rear-end surface (the upper surface) of the sub tank 37. A ring-shaped gasket (not shown) is fitted in the flow passage connection portion 38. The gasket ensures the liquid-tight connection of the connection flow passage 40 to the flow passage connection portion 38. Two driving substrates (not shown) are provided inside the sub tank 37. The driving substrates supply driving signals to the pressure generating means. A flexible cable 55 (wiring member) is electrically connected to each of the two driving substrates. The two flexible cables 55 are wired with exposure at the rear-end-surface side of the sub tank 37. The flexible cables 55 are connected to the signal cable 15. The driving signals, etc., sent through the signal cable 15 from the control unit of the printer 1 flow through the flexible cables 55 to be supplied to the pressure generating means via the driving substrates.

A phenomenon that occurs when ink goes into the gap d between the recording heads 18 attached to the sub carriage 26 in side-by-side arrangement as described above will now be explained.

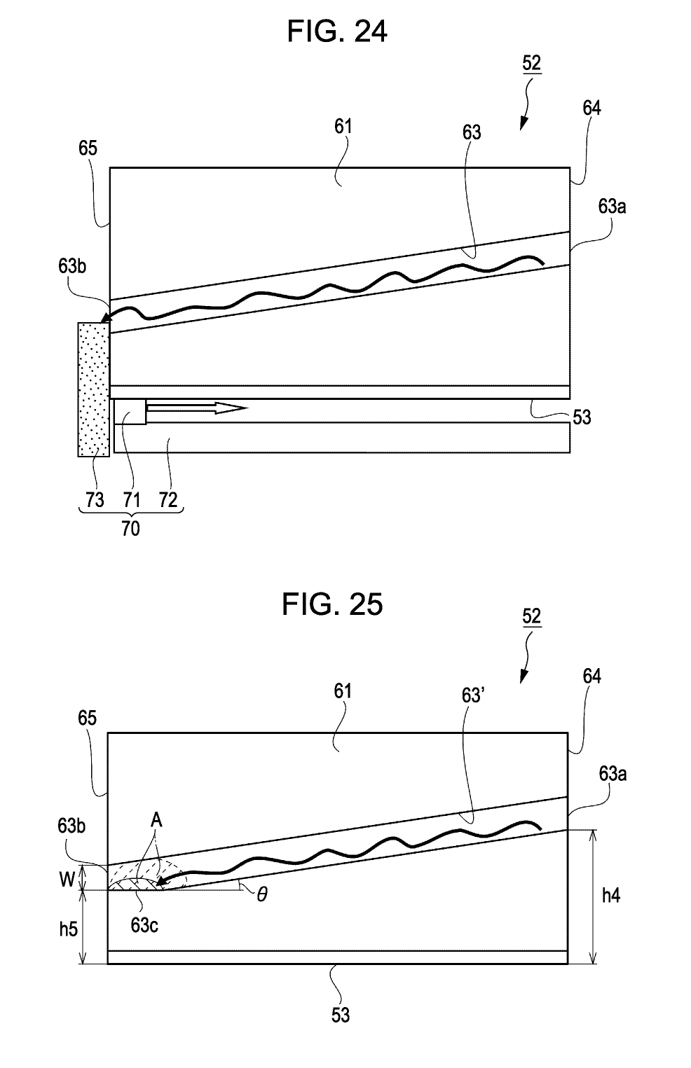

For example, when the nozzle formation surface 53 of each recording head 18 attached to the sub carriage 26 is wiped by means of a wiper blade 71 (which corresponds to a wiping member according to an aspect of the invention) (refer to FIG. 24) after the ejection of ink from the nozzles 51, ink sticking to the nozzle formation surface 53 is gathered up by the wiper blade 71. In some cases, a part of the gathered ink goes into the gap d between the recording heads 18 attached next to each other. If no measures are taken in a structure in which the gap d between two recording heads 18 is set at a value that causes a capillary flow in relation to surface tension, ink that has gone into the gap d goes from the nozzle-formation-surface (53) side toward the opposite side, that is, toward the rear-end surface of the sub tanks 37, along the facing side surfaces 60 and 61 (described later) of the recording heads 18 attached next to each other. That is, the ink spontaneously rises against gravity due to capillary action. Therefore, in related art, there is a risk of the sticking of the ink that has risen along the facing side surfaces 60 and 61 to the flexible cables 55 wired at the rear-end-surface side of the sub tanks 37, resulting in a short-circuit failure of the flexible cables 55.

A condition for ink to rise in the gap d is calculated on the basis of a relationship between the gap d and surface tension (a value of the physical properties of the ink), density (a value of the physical properties of the ink), and an angle of contact (the material, surface roughness, etc. of solid surrounding surfaces). The rising condition can be expressed by the following general formula of the surface tension of ink (1). In other words, ink that has gone into the gap d spontaneously rises due to capillary action when the surface tension of the ink is greater than the force of gravity.

(2s·cos θ/r)>ρgh (1)

In the above formula (1), s denotes surface tension (the surface tension of ink is approximately 30 mN/m); θ denotes contact angle (5 to 10°); r denotes radius (in this example, a half of the gap d, that is, d/2); and ρ denotes density (the density of ink is equal to the density of water, that is, 1 g/cm³).

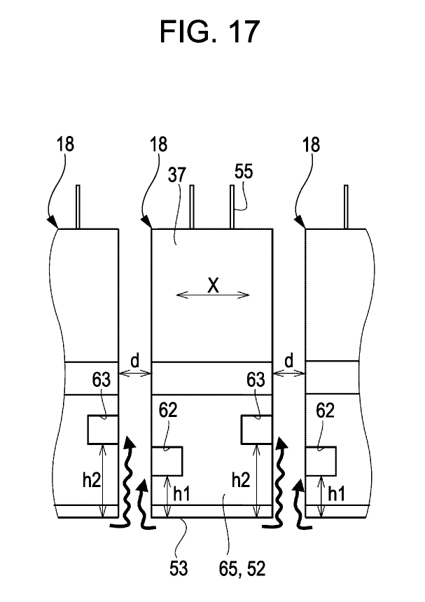

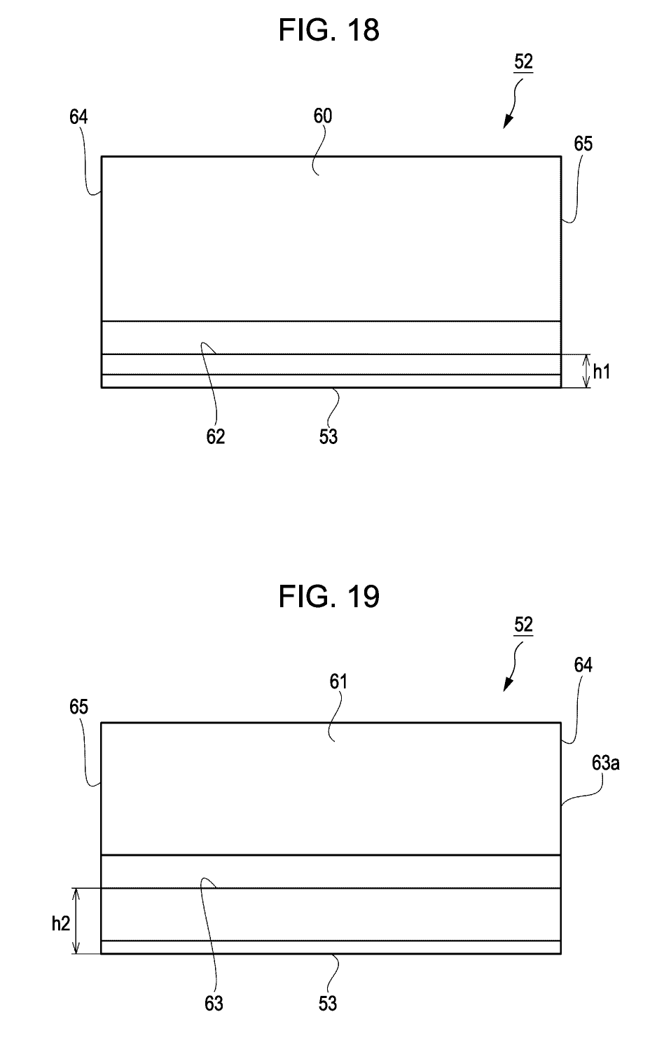

FIG. 17 is a front view that schematically illustrates an example of a part of the structure of the recording heads 18 arranged side by side. FIG. 18 is a right side view of the head case 52. FIG. 19 is a left side view of the head case 52.

In view of the above problem, the head unit 17 according to the present embodiment of the invention is characterized in that the grooves 62 and 63 are formed respectively in one of the opposed side surfaces (facing side surfaces) of each two adjacent recording heads 18 arranged side by side (the left side of a recording head 18 shown in FIG. 17) (hereinafter referred to as “the left side surface 60”) and the other (the right side in FIG. 17) (hereinafter referred to as “the right side surface 61”). The groove 62 formed in the left side surface 60 extends from one of two lateral surfaces that intersect with the left side surface 60 (the left side in FIG. 18) (hereinafter referred to as “rear surface 64”) to the other (the right side in FIG. 18) (hereinafter referred to as “front surface 65”). The groove 63 formed in the right side surface 61 also extends from the rear surface 64 to the front surface 65. The two surfaces intersecting with the side surfaces 60 and 61 are hereinafter referred to as “intersecting side surfaces”. The facing side surfaces 60 and 61 extend in the direction of the nozzle lines 56. The intersecting side surfaces 64 and 65 extend in the direction orthogonal to the nozzle-line direction. Though the height of the facing side surfaces 60 and 61 from the nozzle formation surface 53 is the same as the height of the intersecting side surfaces 64 and 65 from the nozzle formation surface 53, the breadth of the facing side surfaces 60 and 61 is far larger than the breadth of the intersecting side surfaces 64 and 65. The two grooves 62 and 63, which are parallel to the nozzle formation surface 53, are formed in the surfaces 60 and 61 at the respective sides of the head case 52 of each of the plurality of recording heads 18 as viewed in the side-by-side-arrangement direction X. That is, the grooves 62 and 63 are formed respectively in the side surfaces 60 and 61 of the head case 52, which is exposed and not covered by any cover member or the like that covers the nozzle formation surface 53 of the recording head 18. The groove 62, 63 described above may be formed in either one of the opposed side surfaces 60 and 61 of each two adjacent recording heads 18 arranged side by side.

The height (distance) from the nozzle formation surface 53 to the bottom of each groove 62 formed in the side surface 60 is different from the height from the nozzle formation surface 53 to the bottom of each groove 63 formed in the side surface 61. Specifically, the height from the nozzle formation surface 53 to the bottom of the groove 62 formed in the left side surface 60 (the height is denoted as h1 in FIG. 18) (the groove 62 is hereinafter referred to as “lower groove”) is less than the height from the nozzle formation surface 53 to the bottom of the groove 63 formed in the right side surface 61 (the height is denoted as h2 in FIG. 19) (the groove 63 is hereinafter referred to as “upper groove”). That is, the lower groove 62 is closer to the nozzle formation surface 53 as compared with the upper groove 63.

When the nozzle formation surface 53 of each recording head 18 is wiped by means of the wiper blade 71 after the ejection of ink from the nozzles 51, the wiper blade 71 gathers up ink sticking to the nozzle formation surface 53. In some cases, a part of the gathered ink goes into the gap d between the recording heads 18 attached next to each other. Since the gap d each between the recording heads 18 of the head unit 17 according to the present embodiment of the invention is set at a value that causes a capillary flow in relation to surface tension, ink that has gone into the gap d spontaneously rises from the nozzle-formation-surface (53) side toward the opposite side, that is, toward the rear-end surface of the sub tanks 37, along the facing side surfaces 60 and 61 of the recording heads 18 attached next to each other (the capillary flow of the ink is shown by thick arrows in FIG. 17). However, the lower groove 62 traps the ink rising in the gap d along the facing side surfaces 60 and 61. Then, even when there is some ink that is still rising without being trapped by the lower groove 62, the upper groove 63 traps it. Because of such a trapping structure, ink that has gone into the gap d and rises due to capillary action does not reach the flexible cables 55. Therefore, even though the flexible cables 55 are wired at the side opposite to the nozzle-formation-surface (53) side, the sticking of the ink to the flexible cables 55 does not occur.

As described above, in the printer 1 according to the present embodiment of the invention, the grooves 62 and 63 are formed respectively in the opposed side surfaces, that is, the left side surface 60 and the right side surface 61 of each two adjacent recording heads 18 arranged side by side. In addition, the groove 62, 63 formed in the side surface 60, 61 extends from the rear surface 64, which intersects with the side surface 60, 61, to the front surface 65, which also intersects with the side surface 60, 61. Therefore, in a case where ink stuck to the nozzle formation surface 53 through the process of ink ejection is gathered up in a wiping process by means of the wiper blade 71 to partially go into the gap d and then rise in the gap d due to capillary action, the lower groove 62 and the upper groove 63 trap the ink. Therefore, it is possible to prevent the ink from reaching the side opposite to the nozzle-formation-surface (53) side. Specifically, a capillary force exerted on the ink in the gap d between the recording heads 18 is interrupted at regions where the grooves 62 and 63 are formed. Because of the disabled capillarity, it is hard for the ink to pass over the grooves 62 and 63. In addition, in a case where a mist generated around the nozzles 51 due to, for example, the ejection of ink goes into the gap d between the recording heads 18 attached next to each other and then goes from the nozzle-formation-surface (53) side toward the opposite side, the lower groove 62 and the upper groove 63 trap the mist. Consequently, such a trapping structure increases the reliability of the recording heads 18. That is, it is possible to prevent ink or a mist from sticking to the flexible cables 55 wired at the side opposite to the nozzle-formation-surface (53) side. Thus, short-circuiting and other failures of the flexible cables 55 do not occur.

Moreover, in a structure in which the grooves 62 and 63 are formed respectively in one 60 and the other 61 of the opposed side surfaces of each two adjacent recording heads 18 arranged side by side, since the height from the nozzle formation surface 53 to the bottom of each groove 62 formed in the side surface 60 is different from the height from the nozzle formation surface 53 to the bottom of each groove 63 formed in the side surface 61, it is possible to prevent interference between the groove 62 formed in the side surface 60 and the groove 63 formed in the side surface 61. If the level of the groove 62 is equal to the level of the groove 63, there is a risk of the mixing of ink trapped by the groove 62 formed in the side surface 60 and ink trapped by the groove 63 formed in the side surface 61, which decreases the ink-retaining capability of the grooves 62 and 63. In such a case, there is a risk of the dropping of the ink retained in the grooves 62 and 63 from the grooves 62 and 63 due to its own weight. This does not occur with the structure disclosed in the present embodiment of the invention. Thus, it is possible to prevent a liquid ejection target medium or the inside of the printer 1 from stained by ink dropping from the grooves 62 and 63.

The scope of the invention is not limited to the specific embodiments described above. The invention may be modified, altered, changed, adapted, and/or improved without departing from the gist and/or spirit thereof apprehended by a person skilled in the art from explicit and implicit description given herein. Such a modification and the like are also encompassed within the scope of the appended claims.

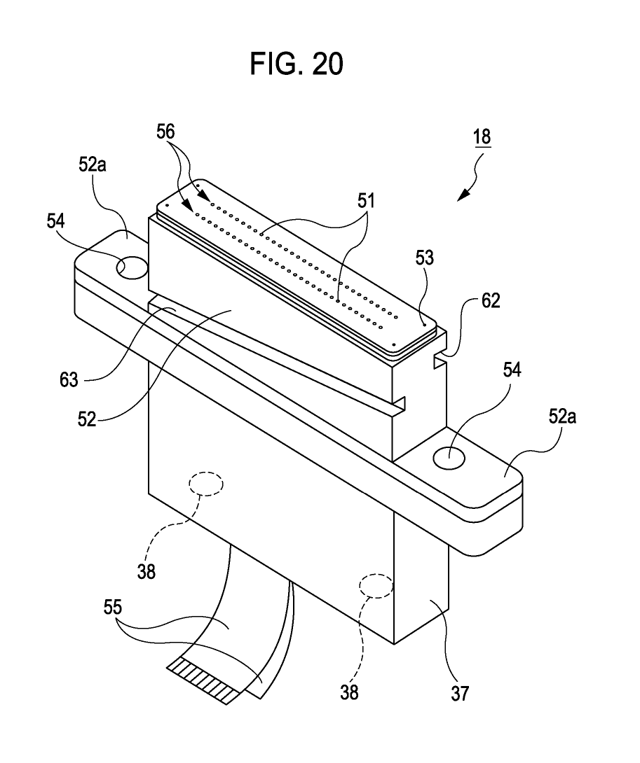

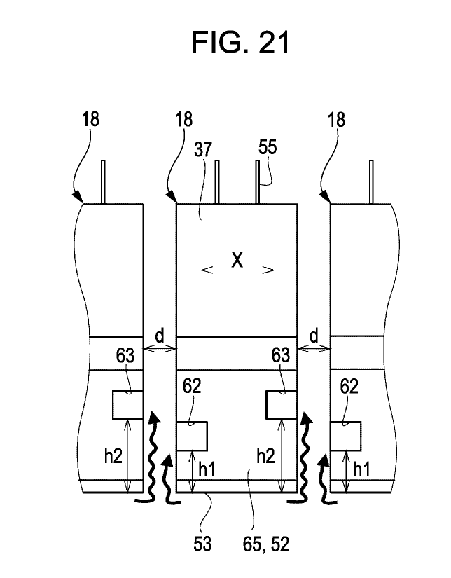

The grooves 62 and 63 that are formed respectively in the side surfaces 60 and 61 of the head case 52 of the recording head 18 according to a second embodiment of the invention will now be explained with reference to FIGS. 20 to 24. The present embodiment is different from the first embodiment described above in the following points. Firstly, the lower groove 62 and the upper groove 63 are inclined with respect to the nozzle formation surface 53. Secondly, a maintenance mechanism 70, which is used for wiping off ink that stuck to the nozzle formation surface 53 through the process of ink ejection or the like is provided at the home position of the printer 1. Except for the above points of difference, the structure of the second embodiment is the same as that of the first embodiment. The same part of the structure is not explained in detail here.

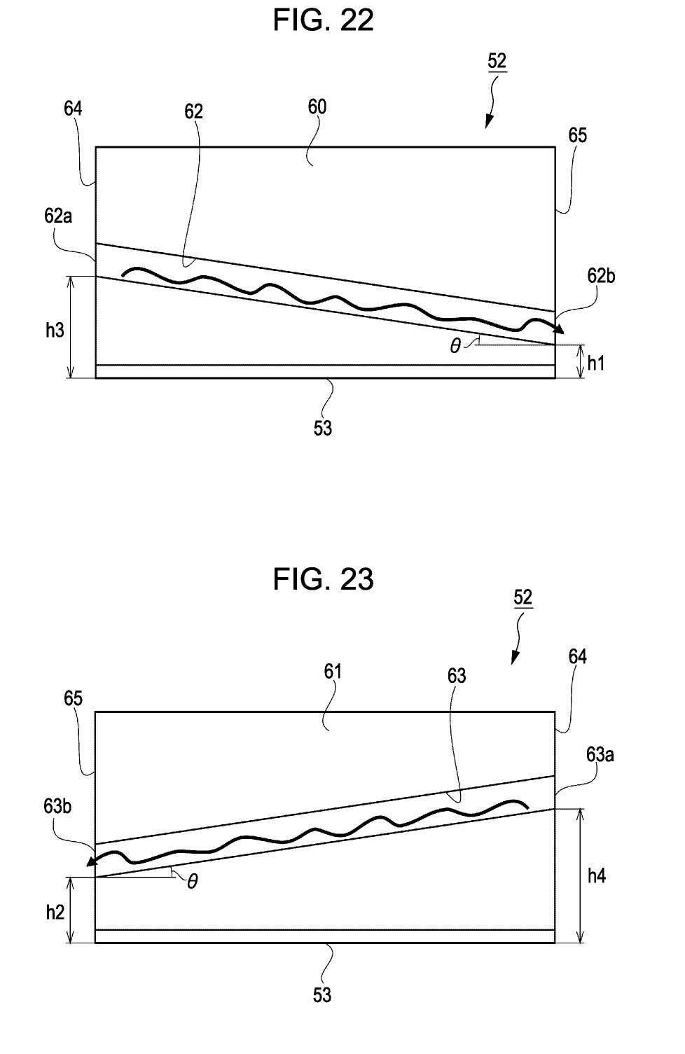

Specifically, the lower groove 62 according to the present embodiment of the invention slopes down with respect to the nozzle formation surface 53 from the head of a slope at the rear surface 64, that is, an upper inclination end 62a (the height from the nozzle formation surface 53 is denoted as h3 in FIG. 22), to the foot of the slope at the front surface 65, that is, a lower inclination end 62b (the height from the nozzle formation surface 53 is denoted as h1 in FIG. 22). The angle of inclination is denoted as θ in FIG. 22. The upper groove 63 according to the present embodiment of the invention slopes down with respect to the nozzle formation surface 53 from the head of a slope at the rear surface 64, that is, an upper inclination end 63a (the height from the nozzle formation surface 53 is denoted as h4 in FIG. 23, where h3<h4), to the foot of the slope at the front surface 65, that is, a lower inclination end 63b (the height from the nozzle formation surface 53 is denoted as h2 in FIG. 23, where h1<h2). The angle of inclination is denoted as θ in FIG. 23. In other words, the upper groove 63, which extends in parallel with the lower groove 62, is relatively distant from the nozzle formation surface 53. Because of the inclined structure described above, ink that has gone into the groove 62, 63 flows down the slope to gather at the lower inclination end 62b, 63b due to its own weight.

FIG. 24 is a diagram that schematically illustrates an example of the structure of the maintenance mechanism 70. The maintenance mechanism 70, which is provided at the home position of the printer 1, includes the wiper blade 71 (which corresponds to a wiping member according to an aspect of the invention) for wiping the nozzle formation surface 53, a blade support unit 72 (which corresponds to a supporting section according to an aspect of the invention) for supporting the wiper blade 71, and an absorber 73 for absorbing ink, for example, a sponge. The blade support unit 72 has the shape of a flat plate that is installed in parallel with the nozzle formation surface 53. The wiper blade 71 is made of an elastic material such as rubber, elastomer, or the like. The wiper blade 71 is provided as a blade that protrudes, toward the nozzle formation surface 53, from an upstream end in the direction of the movement of the blade support unit 72 during wiping operation (note that the wiping direction is shown by an empty arrow in FIG. 24). The wiper blade 71 is formed as a plate-like member that extends in the direction orthogonal to the direction of the nozzle lines 56 (in the depth direction in FIG. 24). That is, the nozzle formation surface 53 is wiped in the nozzle-line direction by the wiper blade 71 as the blade support unit 72 moves (so-called vertical wiping). The absorber 73 is provided at an upstream end in the direction of the movement of the blade support unit 72 in a state in which it is positioned adjacent to the blade support unit 72. The absorber 73 is configured as an independent member that can be separated from the blade support unit 72 when wiping operation is performed. The maintenance mechanism 70 is configured to absorb ink in the following way. The wiper blade 71 is brought into contact with the nozzle formation surface 53 at the time of wiping operation. When the wiper blade 71 is brought into contact therewith, the absorber 73 is brought into contact with the lower inclination end 62b of the lower groove 62 and the lower inclination end 63b of the upper groove 63. The absorber 73 absorbs ink that is retained at the lower inclination ends 62b and 63b. Therefore, each time when the nozzle formation surface 53 is wiped by means of the wiper blade 71, it is possible to collect ink that gathers at the lower inclination ends 62b and 63b by using the absorber 73.

The structure of the maintenance mechanism 70 may be modified as follows. The absorber 73 is provided in a capping unit (not shown) that is used for capping the nozzle formation surface 53 of the recording head 18 that is in a stationary state on standby. A cap member (not shown) is brought into contact with the nozzle formation surface 53 at the time of cleaning operation. In the cleaning operation, negative pressure is applied to the nozzle formation surface 53 by means of a pump or the like in a state in which the nozzle formation surface 53 is sealed by the cap member to suck ink and air bubbles out of the nozzles 51. When the cap member is brought into contact with the nozzle formation surface 53, the absorber 73 is brought into contact with the lower inclination end 62b of the lower groove 62 and the lower inclination end 63b of the upper groove 63. The absorber 73 absorbs ink that is retained at the lower inclination ends 62b and 63b.

FIG. 25 is a left side view of the head case 52 of the recording head 18 according to a third embodiment of the invention. The present embodiment is different from the second embodiment described above in the following point. A surface 63c that is parallel to the nozzle formation surface 53 is formed as a part of, among inner surfaces that constitute an upper groove 63′, an inner surface that is located at the nozzle-formation-surface (53) side. The parallel surface 63c is formed near the lower inclination end 63b of the upper groove 63′, which is formed in the side surface 61 of the head case 52. The height from the nozzle formation surface 53 to the parallel surface 63c at the lower inclination end 63b (denoted as h5 in FIG. 25, where h2<h5) is greater than the height from the nozzle formation surface 53 to the bottom end of the upper groove 63 according to the second embodiment. This means that the width of the lower-inclination-end-side (63b) portion of the upper groove 63′ according to the present embodiment of the invention decreases gradually toward the lower inclination end 63b. Specifically, the width of the upper groove 63′ at the lower inclination end 63b is set at a value (denoted as W in FIG. 25) that ensures that a capillary force will be exerted on ink (denoted as A in FIG. 25) inside the upper groove 63′, thereby making it possible to retain the ink inside the upper groove 63′. Though not illustrated in the drawings, the lower-inclination-end-side (62b) portion of a lower groove 62′ according to the present embodiment of the invention has the same structure as that of the lower-inclination-end-side (63b) portion of the upper groove 63′. That is, the width of the lower groove 62′ at the lower inclination end 62b is set at a value that ensures that a capillary force will be exerted on ink A inside the lower groove 62′. With the structure described above, it is possible to retain ink that has gathered at the lower inclination end 62b of the lower groove 62′ and the lower inclination end 63b of the upper groove 63′. Consequently, it is possible to prevent the ink A trapped by the grooves 62′ and 63′ from dropping due to its own weight.

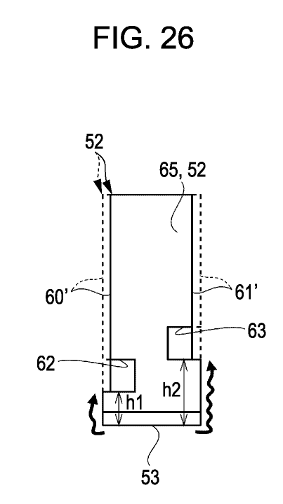

FIG. 26 is a front view of the head case 52 of the recording head 18 according to a fourth embodiment of the invention. As a point of difference between the present embodiment and the embodiments described above, as measured in the side-by-side-arrangement direction X, the thickness of the head case 52 according to the present embodiment of the invention at the side opposite to the nozzle-formation-surface (53) side (that is, at the flexible-cable (55) side) is less than the thickness thereof at the nozzle-formation-surface (53) side. Each of the grooves 62 and 63 is formed at a border between the relatively thick part and the relatively thin part of the head case 52. In other words, each of the side surfaces 60′ and 61′ of the head case 52 has a difference in level between one side as viewed from the corresponding border groove 62, 63 and the other side. Specifically, the part at the side opposite to the nozzle-formation-surface (53) side is recessed with respect to the part at the nozzle-formation-surface (53) side. Because of the above structure, among inner surfaces that constitute the groove 62, 63, an inner surface that is located at the nozzle-formation-surface (53) side, that is, the bottom surface, extends outward in a plan view beyond the plane of the recessed part of the side surface 60′, 61′, that is, the part recessed at the side opposite to the nozzle-formation-surface (53) side with the groove 62, 63 formed at the border therebetween. Since the bottom surface of the groove 62, 63 extends beyond the plane, even when ink flows down from the side opposite to the nozzle-formation-surface (53) side toward the nozzle-formation-surface (53) side, the bottom surface receives the ink. By this means, it is possible to retain the ink at the groove 62, 63.

In a case where the gap d between two recording heads 18 is wider than a gap that causes a capillary flow in relation to the surface tension of ink, the width of each of the grooves 62 and 63 may be set at a value that causes a capillary flow in relation to the surface tension of ink throughout its length. With such a structure, it is possible to retain ink that has gone into the groove 62, 63 by means of the groove 62, 63.

In the foregoing embodiments of the invention, the printer 1 is taken as an example of a liquid ejecting apparatus according to an aspect of the invention. Notwithstanding the foregoing, however, the invention can be applied to various liquid ejecting apparatuses. For example, the invention can be applied to, without any limitation thereto: a display manufacturing apparatus for the production of a color filter for a liquid crystal display or the like; an electrode manufacturing apparatus that is used for the electrode formation of an organic electroluminescence (EL) display, a surface/plane emission display (FED), and the like; and a chip manufacturing apparatus that is used for the production of biochips.

What is claimed is:

1. A liquid ejecting apparatus comprising:
a plurality of liquid ejecting heads for ejecting liquid from nozzles, the liquid ejecting heads arranged side by side with a gap each therebetween, each of the liquid ejecting heads including
one side surface in a direction of side-by-side arrangement;
the other side surface in the direction of side-by-side arrangement;
a groove; and
intersecting side surfaces, which intersect with the side surfaces,
wherein the groove is formed in either one, or both, of opposed side surfaces of each two adjacent liquid ejecting heads arranged side by side, and
the groove formed in the side surface or formed in each of the side surfaces extends from one of the intersecting side surfaces to the other.

2. The liquid ejecting apparatus according to claim 1, wherein the groove is formed in both of the opposed side surfaces of each two adjacent liquid ejecting heads arranged side by side; and a height from a nozzle formation surface, in which the nozzles are formed, to the groove formed in one of the opposed side surfaces is different from a height from the nozzle formation surface to the groove formed in the other.

3. The liquid ejecting apparatus according to claim 1, wherein the groove is inclined with respect to the nozzle formation surface.

4. The liquid ejecting apparatus according to claim 3, wherein a width of the inclined groove at, at least, a lower inclination end thereof is set at a value that ensures that a capillary force will be exerted on the liquid inside the groove, thereby making it possible to retain the liquid inside the groove.

5. The liquid ejecting apparatus according to claim 3, further comprising
a maintenance mechanism that includes
a wiping member for wiping the nozzle formation surface, and
a supporting section that supports the wiping member and brings the wiping member into contact with the nozzle formation surface at the time of wiping, and
an absorber that absorbs the liquid in a state in which the absorber is positioned adjacent to the supporting section,
wherein, when the wiping member is brought into contact with the nozzle formation surface, the absorber is brought into contact with the lower inclination end of the groove so as to absorb the liquid that is retained at the lower inclination end.
